(19) United States
(12) Patent Application Publication
(10) Pub. No.: US 2009/0192046 A1
(43) Pub. Date: Jul. 30, 2009

(54) Chemo-selective identification of therapeutics

(76) Inventors: Daniel R. Soppet, McLean, VA (US); Stephen K. Horrigan, Poolesville, MD (US); Paul Young, Sudbury, MA (US); James Meade, Germantown, MD (US)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 12/309,259

(22) PCT Filed: Jul. 9, 2007
(86) PCT No.: PCT/US07/15726

§ 371 Date: Jan. 12, 2009

Related U.S. Application Data
(60) Provisional application No. 60/819,962, filed on Jul. 11, 2006.

(51) Int. Cl. C40B 30/02

(52) U.S. Cl. 506/8

(57) ABSTRACT

Disclosed is the use of a therapeutic filter for simultaneous screening against multiple targets coupled with subsequent in silico drug discovery utilizing biologically active compounds for the identification and selection of gene sets having characteristic expression profiles for formation of an active compound database with subsequent identification of therapeutically effective agents by scanning and matching in said active compound database.

This application claims priority of U.S. Provisional Application 60/819,962,filed 11 Jul. 2006, the disclosure of which is hereby incorporated by reference in its entirety.

### FIELD OF THE INVENTION

The present invention relates generally to the field of identification of therapeutic agents, such as anti-cancer agents, by using a therapeutic filtration method employing gene profiling and database generation and matching.

### BACKGROUND OF THE INVENTION

Many different agents are known to possess biological and/or therapeutic activity. For some of these the molecular mechanism of action is known and may be determined to be related to each other in terms of mode of action or the molecular pathway affected. Such common activities may often cause similar effects on gene expression, and related compounds may affect similar parts of the genome in a similar way. Similarity in activity may derive from similar structure and/or shape of the molecules involved, and structural motifs may point the way toward additional candidates for examination of biological and/or therapeutic effects. Conversely, such compounds may possess similar activity even though their overall structure or shape may be different so that the establishment of structure/activity relationships may not be particularly helpful in identifying further candidates for study.

Furthermore, many approaches to screening chemical compounds as potential therapeutic agents rely on use of cells in culture and, in order to minimize variability, such cells are commonly members of the same cell line or are cells derived from the same organs or tissues. Despite this, diverse cell types (i.e., cells of a different cell line or derived from different organs or tissues) may be related in terms of their susceptibility to a test compound that may act by modifying the expression profile of a given set of genes within the genome of the cell type being studied. From such results, an expression profile may be formulated for a given gene set, the latter being some subset of the genome of the cell, and this expression profile may be modulated by the presence of a particular chemical agent.

When a cell is treated with a chemical compound that binds to, and either activates or represses a biomolecule (such as a gene, or other polynucleotide, or a protein) in a cell, this action sets off a ripple effect in the cell resulting in the expression of many other genes in the cell being either directly or indirectly increased or repressed. In general, when compounds have effects on cells, it is not unusual to note that the expression of more than one gene, or protein, possibly many such, say up to at least 10% of genes, or proteins, in the cell may be affected. For example, if gene expression were being studied using an array system containing y number of genes, some “x” number of genes might show the effects of a response to the chemical agent by an increase or decrease in expression. Alternatively, a set of proteins may be modulated upward or downward, each member of the set to more or less extent. Given the high number of genes or proteins whose activity may be modulated in a specific way as a result of contact with a selected chemical agent, it is highly advantageous to develop treatment signatures from a smaller number of selected genes or proteins in a panel rather than screening a large number of cellular genes or proteins to develop a reporter set specific to each type of modulating profile or signature.

Heretofore, methods for drug discovery have often been based upon the use of specific gene expression profiles. For example, an inhibitor, such as an siRNA (small interferring RNA) designed against a particular gene, is inserted into cells and used to inhibit the expression of that gene. Of course, methods other than RNAi can be used to inhibit the desired target, including but not limited to antisense, site-directed mutagenesis, and chemical compounds. RNA from cells treated with and without RNAi is then isolated and hybridized to target polynucleotides, for example, using gene expression microarrays, to identify genes whose transcription is reproducibly altered (either increased or decreased) as a result of inhibition of the target gene. This process results in a gene expression profile, or signature, that can report on inhibition of a target gene or target gene pathway. Typically, 5-10 genes are selected from this signature and used, for example, in high throughput screening (HTS) procedures to identify chemical compounds that cause changes in gene expression matching the aforementioned siRNA gene expression inhibition profiles. Such compounds then represent candidate molecules that may modulate, for example inhibit, the desired target or target pathway. Following development of the signature, there is time and significant cost associated with running the HTS and identification of hits.

In current methods, one could, for example, utilize siRNA's against a target gene and screen a microarray (2000-30,000 genes) to identify a specific set of 5-10 signature genes associated with inhibition of that target. Here, the user is searching for genes with stable signatures during a defined time period, e.g. 24-48 hours after exposure to test compounds and with significant movements (up or down) that will stand out from the noise in a qPCR reaction.

The present invention solves these problems. In the process disclosed herein, one uses a modulator, for example, an siRNA against a target gene, but screens only a select set of genes (e.g. 30-60) that are known to be informative screening genes in the cell line of choice, rather than all of the genes on a typical microarray chip. This allows establishment of a signature against a standard set of genes in a few days rather than weeks and at significantly lower expense.

The description of prior procedures has focused on the construction of a specific gene signature that selectively reports on inhibition of a specific target, and the emphasis has been placed on rigorous selection of a specific gene set linked to a specific target. Unlike the present invention, there was no concept at the time that a more general gene set could simultaneously report on inhibition of multiple targets. Also previously presented has been the concept of Compound-Centric Gene profiles/Compound Classifiers, and the use of a gene profile to report on mechanism-of-action. Again, the emphasis was on the selectivity of a gene profile for identification of a specific mechanism and not the concept that a gene profile could be simultaneously used to identify and define multiple, distinct activities for various compounds.

### BRIEF SUMMARY OF THE INVENTION

In one aspect the present invention relates to a method for identifying one or more members of a compound library having physiological activity similar to that of a reference treatment. Reference treatments can be any agent that modulates the activity of genes making up a selected set of genes and may include, but is not limited to, such agents as small interfering RNAs (siRNAs) and anti-sense compounds, such as anti-sense RNA; biological agents such as peptides, proteins, or antibodies; or small molecule compounds of known or unknown specificity. Such reference treatment may increase or decrease the activity of said genes.

In particular, the method comprises:

(a) maintaining in a database gene expression patterns produced by individual compounds of a library of compounds, said gene expression patterns having been obtained for each of a selected set of genes in a cell, which set of genes and cell is the same for each of said individual compounds;

(b) obtaining a gene expression pattern for a reference treatment for said selected set of genes in said cell;

(c) comparing said gene expression pattern for said reference treatment with said gene expression pattern for each library compound of said library; and

(d) selecting one or more compounds of said library for testing for activity based on similarity between said gene expression pattern for said library compound and said gene expression pattern for said reference treatment.

thereby identifying one or more members of a compound library having activity similar to that of a reference treatment.

In carrying out the methods of the invention it is not necessary to determine the effect of the members of the compound library or a reference treatment on all genes of the genome and fewer than all such genes may be utilized. The selected set of genes may comprise 200 or fewer genes, fewer than 100 genes, as few as 50 genes, or even 40 genes may comprise the selected set. In addition, as few as 10 genes may comprise the selected set of genes. In one embodiment, only 9 genes comprise the selected set and in other preferred embodiments at least 9 genes will comprise the selected set of genes.

The compound library of step (a) may comprise any number of compounds. A typical small molecule compound library may comprise hundreds of thousands or millions of compounds, although in some instances there may be more or fewer compounds Importantly, the compounds of the compound library need be screened only once, using a given cell type and set of physiological conditions. Some of the data may have been obtained in silico (i.e., from already assembled databases) so that not all of the gene expression or other biological data need be determined de novo using wet bench procedures. The resulting gene expression data is assembled into a database (referred to herein as the compound library treatments database), especially one easily accessible to computerized searching. Such searching is designed to facilitate the comparing feature of step (c) so that the latter is preferably done in silico (i.e., using a computer as opposed to wet bench or manual analysis). This compound library treatments database may be assembled with or without knowledge of the identity of any reference treatment since the latter is not essential to determination of the member genes of the selected set of genes.

The screen of steps (b and c) may be repeated as many times as is needed to identify desired chemical agents.

In preferred embodiments, the determination of gene expression profiles or patterns in any of the steps of the claimed methods is performed in vitro or in vivo, especially where the genes are present in a cell that is contacted with said library compounds or said reference treatments. The gene expression patterns obtained using the reference treatments may also be stored in a database (referred to herein as the reference treatments database).

The activity of the genes being determined includes any type of activity that measures gene expression, such as transcription, which is commonly measured by determining quantity of RNA, preferably mRNA, following exposure to the modulator or test compound, or may involve determining the quantity of polypeptide and/or the activity of polypeptides encoded by the genes.

### BRIEF DESCRIPTION OF THE DRAWING

FIG. 1. A gene set selected to report on Ral inhibition can accurately identify HDAC inhibitors, wherein nine genes displayed reproducible changes in expression in cells following treatment with Ral siRNA's (FIG. 1a). A distinct, reproducible profile is induced across the same gene set with multiple, reference histone deacetylase (HDAC) inhibitors (FIG. 1b).

### DEFINITIONS

As used herein, unless expressly stated otherwise, the following terms have the indicated meaning.

The terms “DNA segment” or “DNA sequence” or “nucleotide sequence” refers to a heteropolymer of deoxyribonucleotides. Generally, DNA segments encoding the proteins provided by this invention are assembled from cDNA fragments and short oligonucleotide linkers, or from a series of oligonucleotides, to provide a synthetic gene which is capable of being expressed in a recombinant transcriptional unit comprising regulatory elements derived from a microbial or viral operon. As used herein, reference to a DNA sequence includes both single stranded and double stranded DNA. Thus, the specific sequence, unless the context indicates otherwise, refers to the single strand DNA of such sequence, the duplex of such sequence with its complement (double stranded DNA) and the complement of such sequence.

The term “transcript” refers to the product of transcription of a first nucleotide sequence, especially a polydeoxynucleotide sequence, to form a second nucleotide sequence that is complementary to said first nucleotide sequence, where said transcription is catalyzed by an enzyme. The transcript will commonly be some type of RNA, especially messenger RNA (mRNA).

The term “gene expression” refers to the activity of a gene in causing a physiological change in a cell, which can be accomplished by transcription of the gene to produce an RNA that is subsequently translated into a protein, such as one having enzymatic activity. Genes are commonly expressed by being transcribed and such transcription can be measured by determining RNA produced (the transcript) or by determining production of polypeptides encoded by the genes or the activity of such polypeptides, which is itself a measure of the amount of polypeptide produced and thus is a measure of gene expression. As used herein, gene expression can be measured by measuring any parameter that quantitatively indicates the extent to which the gene is being expressed Such expression may also be measured qualitatively, such as where one gene is expressed and another gene is not.

The term “expression product” means that polypeptide or protein that is the natural translation product of the gene and any nucleic acid sequence coding equivalents resulting from genetic code degeneracy and thus coding for the same amino acid(s). When used loosely, the term “expression product” can also include a transcript although it is not so used herein, unless expressly stated as such.

The term “promoter” means a region of DNA involved in binding of RNA polymerase to initiate transcription. The term “enhancer” refers to a region of DNA that, when present and active, has the effect of increasing expression of a different DNA sequence that is being expressed, thereby increasing the amount of expression product formed from said different DNA sequence.

As used herein, the terms “gene expression profile” or “gene expression pattern” or “gene expression fingerprint” or “gene activity profile” or “gene expression signature” are interchangeable and refer to the pattern of change in the relative levels of the genes within the profile resulting from treatment of cells with members of a set of chemical agents. The changes in expression levels of genes within the set are compared in relationship to each other to determine the profile. In one example, for a set of 10 genes, possibly genes 1-6 are reduced in expression and genes 7-10 are increased in expression after contact with each of a set of agents having common biological activity. The profile or fingerprint will include the relative degree of increase or decrease of expression of the genes of the set in response to the presence of a given concentration of an established biologically active agent at a certain timepoint (for example, expression of gene 1 may be reduced by half, gene 2 by ⅔, gene 3 not expressed at all, gene 7 doubled in expression, gene 10 increased 3 fold in expression, and so on in response to each of the compounds of the set and relative to the steady state levels of said genes). Individual genes within the set that do not display a change in expression level following treatment can still be informative and may represent key elements of a profile or fingerprint. In the typical case, compound A is introduced into the growth medium of the cells. The result is a gene expression profile, or gene expression fingerprint, or expression fingerprint, for compound A and other compounds possessing common biological activity.

The term “activity profile” can also refer to the pattern of effects of a test compound or modulator on a plurality of genes, or on a selected set, where the activity being measured is the relative activities or amounts of expression products encoded by the plurality of genes or selected set.

The term “selected set” or “selected set of genes” refers to a subset of the genome of a selected cell type wherein said subset comprises genes that are representative of the state of metabolism or other physiological state of a cell of the type in question, or is representative of the genes affected by a specific disease state, such as cancer, diabetes, or other pathological condition, or representative of a portion of the cell cycle, such as the replicative or dormant phase of the life of the cell. Such selected set is identified by contacting the gene set, or a cell expressing the gene set, with a test compound where the cell is susceptible to the test compound and said susceptibility is related to, or caused by, a change in the expression profile of the gene set. When the cell is not contacted with said test compound the expression profile of the selected set would be deemed the basal expression profile. Such a selected set of genes is identified according to the methods of the invention by screening a larger number of genes, including possibly the entire genome, to identify those genes most indicative of the overall state of the cell or most indicative of the presence or absence of a particular pathological condition. Such a selected set will commonly range from a few members, possibly as few as 9 or 10, to as many as 40, or 50, or possibly 100 to 200. Within the usage of the methods of the invention, a selected set would not likely contain more than about 200 genes.

As used herein, the term “test compound” refers to any chemical agent, including small molecule compounds or even larger structures, such as proteins or anti-sense agents, that is applied to cells and that may or may not induce a gene signature or profile following treatment. Test compounds may include, but are not limited to, reference treatments and/or compounds from a small molecule library.

“Basal gene expression” or “baseline gene expression” or “steady state expression” all refer to the expression of a gene, or set of genes, when said genes, or a cell containing said genes, is not in contact with a test compound. Such expression may be measured by determining amount or rate of synthesis of RNA or protein (i.e., by transcription or translation) of by determining the level of enzyme activity of enzymes encoded by one or more of the genes of a gene set.

### DETAILED SUMMARY OF THE INVENTION

The present invention relates to a method for identifying one or more members of a compound library having physiological activity similar to that of a reference treatment, comprising:

(a) maintaining in a data base gene expression patterns produced by individual compounds of a library of compounds, said gene expression patterns having been obtained for each of a selected set of genes in a cell, which set of genes and cell is the same for each of said individual compounds;

(b) obtaining a gene expression pattern for a reference treatment for said selected set of genes in said cell and comparing said gene expression pattern for said reference treatment with said gene expression pattern for the individual compounds, of said library; and

(c) selecting one or more compounds of said library for testing for physiological activity based on similarity between said gene expression pattern for said library compound and said gene expression pattern for said reference treatment

thereby identifying one or more members of a compound library having physiological activity similar to that of a reference treatment.

As already described, current processes available for drug screening may employ a series of well-defined screens to devise genetic activity profiles in piecemeal fashion. One such screening process might proceed as follows:

Screen 1: Develop Target Gene A RNAi gene expression profile against genes in Cell X using microarrays, select specific genes (e.g. 1 to 10) and then adapt these to qPCR assay. Screen entire compound library against Gene A Profile (genes 1 to 10) using qPCR
Screen 2: Develop Target Gene B RNAi gene expression profile against genes in Cell X using microarrays, select specific genes (e.g. 11 to 20) and then adapt these to a qPCR assay. Screen entire compound library against Gene B Profile (genes 11 to 20) using qPCR
Screen 3: Develop Target Gene C RNAi gene expression profile against genes in Cell X using microarrays, select specific genes (e.g. 21 to 30) and then adapt these to a qPCR assay. Screen entire compound library against Gene C Profile (genes 21 to 30) using qPCR
Screen 4: Develop Target Gene D RNAi gene expression profile against genes in Cell X using microarrays, select specific genes (e.g. 31 to 40) and then adapt these to a qPCR assay. Screen entire compound library against Gene D Profile (genes 31 to 40) using qPCR
to
Screen N: Develop Target Gene N RNAi gene expression profile against genes in Cell X using microarrays, select specific genes (e.g. x to y) and then adapt these to a qPCR assay. Screen entire compound library against Gene N Profile (genes x to y) using qPCR

In accordance with the present invention, such a screen would, instead, proceed as follows:

Screen 1: Develop Target Gene A RNAi gene expression profile in Cell X against the genes in the panel (x genes) using qPCR. Screen entire compound library against Panel Genes (x genes) using qPCR and look for those that match the Gene A RNAi Profile.
and
Screen 2: Develop Target Gene B RNAi gene expression profile in Cell X against the genes of the panel (same x genes) using qPCR. Screen the profiles generated in Screen 1 “in silico” looking for matches to the Gene B RNAi Profile.
to
Screen N: All additional screens are done as in Screen 2 if one is using the same relevant cell line and growth conditions. If it is necessary to change cell lines or growth conditions so that your target gene is active in the cell, then Screen 1 is repeated to establish the appropriate gene expression database for future in silico screening.

All genes in the panel are part of the profile since their expression is either modulated (up / down) or unchanged by treatment with the Gene X specific RNAi and not modulated by mock transformations or treatment with non-specific RNAi.

In accordance with the present invention, rather than running separate screens involving, say, unique 5-10 gene profiles specific for each target gene, a panel of genes (e.g., 8 to 40 or 50 genes) is selected for use in a single screen. In the present case, a set of only 9 genes was found useful in validating the method of the invention. The present inventive method was used, for example, to identify a known anti-cancer agent as having anti-cancer activity, thereby showing the value of the method. Such a panel of genes could be selected through a variety of approaches including, but not limited to, microarray profiling of the cellular effects of distinct siRNAs, microarray profiling of the cellular effects of reference treatments, selection of known genes-of-interest based on published databases, or any gene that may serve as an effective, downstream readout of a cellular state. All of the compounds in a compound library are then tested in a single high throughput screening (HTS) program using a specific cell line and at a given set of treatment conditions, to determine their individual effect on the expression of each of the genes in the panel. The data is collected and stored in a database for future use (“Compound Library Treatments DB” (DB=database)). In parallel, the same cell line is subjected to treatments with a set of reference reagents (e.g. siRNAs; antisense oligos; reference treatments) that have been documented to affect specific targets, pathways, and/or cellular mechanisms. In one embodiment, following these treatments, RNA is isolated from the cells, profiled for the effect on the expression of each of the genes in the panel, and the data is collected and stored in a database (“Reference Treatments DB”). A number of statistical tools/approaches, including Pearson correlation coefficients, hierarchical clustering, principle component analysis, and random forest visualization, can be used to analyze both databases and establish the following sets of information:

1. Activity binning—or how many distinct profiles are observed across the gene panel. It is likely that distinct profiles are associated with activity against distinct targets or target pools. Through activity binning, one can identify compounds within the library with distinct activities on treated cells.

2. Target/Probe pairs—by matching the profiles observed within the Compound Library Treatments DB with the profiles identified in the Reference Treatments DB, one can determine the putative target, pathway, or mechanism affected by each distinct ‘bin’ of hit compounds.

By way of non-limiting example, if the profile of one ‘bin’ of hit compounds across the gene panel ‘matches’ the profile of reference histone deacetylase (HDAC) inhibitors across the gene panel, then it is likely that the ‘bin’ of hit compounds represents novel HDAC inhibitors.

The present invention presents, for the first time, the principle that a limited set of genes is sufficient to capture and define compounds that are active against multiple targets within a single cell. Only one HTS is required for each cell line run under the same treatment conditions—subsequent primary screens are done in silico (e.g., using a computer) thereby resulting in significant savings in cost and time. Importantly, the compound library treatments database need only be assembled once and then used repeatedly with the gene expression patterns of the selected gene set and one or more reference treatments. The results with the reference treatments can themselves be assembled into a database (the Reference Treatments database) for further future reference.

In a preferred embodiment, a plurality of genes is used to determine a selected set of genes for use in the methods of the invention so that this selected set is a subset of the plurality. Such selected set is commonly derived from the genome of a selected cell or cell type but is much less than the genome. In a separate embodiment, the plurality of genes of step (a) comprises fewer than all of the genes of the genome of the selected cell type. In other preferred embodiments, the total number of genes forming said plurality comprises no more than 10,000 genes, possibly no more than 5,000 genes or even as few as 1,000 genes. It is one factor of the invention that the genes used for screening may contain representative genes of many different pathways in a cell. In accordance with the invention, the screening processes may be conducted as many times as desired using genes or genomes from different cell types, or cells from different cell cultures or cell lines.

In accordance with the present invention, the selected set of genes may be determined according to the following criteria and such selected set will commonly be the same set regardless of the type of screen to be performed or the kind of chemical agents to be identified. Thus, the selected set of genes is the same throughout the methods of the invention. However, if the cell type is different, the identity of the members of the selected set of genes may change (but this is not a necessary feature of the invention).

The invention offers a selected set of genes that is representative of the overall state of activity of the cell and will be the same from one reference treatment to another. In past approaches, this selected set was made up of key regulatory genes that control the state of metabolism or replication of the type of cell under study, or is representative of a particular metabolic pathway of interest, or a particular type of disease process, such as cancer, diabetes, microbial infection and the like. In keeping with the present invention, in carrying out the methods of the invention, this selected set of genes preferably comprises no more than about 200 genes, more preferably no more than about 100 genes, still more preferably no more than about 50 genes, and most preferably no more than about 40 genes. In addition, as few as 20 genes, or fewer, as few as 10 or even at least 9 genes may make up the selected set depending on the type of cell to be investigated. The selected set of genes are probably, but are not limited to, genes whose expression levels can be modulated; genes that represent a sampling of many different pathways in a cell; and genes whose expression levels are not coordinately regulated (i.e. when one gene goes up or down another gene always goes up or down).

In conducting the methods of the invention, the reference treatments may be any type of chemical agent that alters (i.e., modulates) the activity or effect of a gene, or genes. Preferably, such reference treatment will exhibit most, if not all, of its modulating activity on a specific gene, or closely related set of genes, or a specific cellular activity, such as a particular metabolic pathway, or a particular reaction of such a pathway, or a specific cellular process, such as receptor activity to a particular receptor, or kind of receptor, or a process such a cellular proliferation or immunological response. Such reference treatment may therefore increase or decrease the cellular activity being investigated (i.e., being screened for) and will include such agents as siRNAs, which represent a preferred embodiment, or anti-sense molecules, such as anti-sense RNAs.

In accordance with the present invention, the screening of step (a) preferably involves use of a large compound library, wherein all the member compounds, such as small organics, include compounds of similar structural arrangement or having related biological activities, or wherein the compounds of such library are designed to present a variety, large or small, of structural motifs exhibiting a range of biological activities. The screening of step (a) is restricted to the selected set of genes already determined according to the invention. Such a compound library may contain any number of compounds.

In accordance with the invention, the comparing to be performed in step (c) of the canonical method is commonly conducted without the use of wet bench procedures, so that such matching commonly is conducted either manually or, preferably, using some type of computerized procedure (for example, with the “Compound Library Treatments Database”). Such a database will commonly comprise the expression patterns of the selected set of genes with each of the compounds making up the compound library and such a database can be readily scanned using commonly available and well known in silico procedures. The results of the screens of steps (b) and (c) of the method of the invention can also be assembled into a database (a “Reference Treatments Database”).

In conducting the screens of the methods of the invention the expression patterns exhibited by the reference treatments and compound library may be determined in any convenient way. Such activity may commonly be measured as the expression of the genes of the selected set of genes used in the other steps, Such selected set of genes may be studied either in vitro or in vivo and the activity preferably monitored by determining expression of the genes. Such expression is preferably determined by quantitative measure of the RNA transcribed from said genes, such as the amount of mRNA produced versus some baseline value or the rate at which such transcription occurs. For example, where the reference treatment or test compound (from the compound library) is effective at altering the activity of a promoter or enhancer of the gene, such transcription may yield greater or lesser amounts of transcript than baseline or steady state values. Where the reference treatment is an siRNA such modulation is expected to take the form of inhibition as to the gene for which the siRNA is specific but may also involve an increase or decrease in expression of other genes so that the combination of these effects will contribute to establishing the expression patterns of the reference treatment. The same is true for the effects of compounds present in the library of compounds being tested against the selected set of genes. Such transcription is preferably measured using methods such as quantitative polymerase chain reaction (qPCR).

In accordance with the foregoing, an activity profile of the selected set of genes using a modulator or chemical agent that is part of a defined library of test compounds, might be determined as follows, although other means certainly present themselves to those skilled in the art. Model cellular systems using cell lines, primary cells, or tissue samples are maintained in growth medium and may be treated with compounds at a single concentration or at a range of concentrations. At specific times after treatment, cellular RNAs are isolated from the treated cells, primary cells or tissues, which RNAs are indicative of expression of the different genes. The cellular RNA is then subjected to analysis that detects the presence and/or quantity of specific RNA transcripts, which transcripts may then be amplified for detection purposes using standard methodologies, such as, for example, reverse transcriptase polymerase chain reaction (RT-PCR), etc. The presence or absence, or levels, of specific RNA transcripts are determined from these measurements and a metric derived for the type and degree of response of the sample versus the steady state levels of such transcripts when the compound is not present.

The gene expression pattern of the selected gene set may be measured or already known. For measurement, expression is commonly assayed using RNA expression as an indicator. Thus, the greater the level of RNA (messenger RNA) detected the higher the level of expression of the corresponding gene. Thus, gene expression, either absolute or relative, such as here where the expression of several different genes is being quantitatively evaluated and compared in order to establish the gene expression pattern of a test compound (either a reference treatment or one from the compound library treatments database) for example, the genes of a related gene set as disclosed herein, is determined by the relative expression of the RNAs encoded by the various gene members of the set.

RNA may be isolated from samples in a variety of ways, including lysis and denaturation with a phenolic solution containing a chaotropic agent (e.g., triazol) followed by isopropanol precipitation, ethanol wash, and resuspension in aqueous solution; or lysis and denaturation followed by isolation on solid support, such as a Qiagen resin and reconstitution in aqueous solution; or lysis and denaturation in non-phenolic, aqueous solutions followed by enzymatic conversion of RNA to DNA template copies.

Steady state RNA expression levels (i.e., basal expression) for the genes of a selected gene set may be known in the literature or may be determined by methods disclosed below. Such steady state levels of expression are easily determined by any methods that are sensitive, specific and accurate. Such methods include, but are in no way limited to, real time quantitative polymerase chain reaction (PCR), for example, using a Perkin-Elmer 7700 sequence detection system with gene specific primer probe combinations as designed using any of several commercially available software packages, such as Primer Express software, solid support based hybridization array technology using appropriate internal controls for quantitation, including filter, bead, or microchip based arrays, solid support based hybridization arrays using, for example, chemiluminescent, fluorescent, or electrochemical reaction based detection systems.

In one such embodiment, SW480 cells (or other cells of choice, such as those of a selected cell line) are grown to a density of 226 cells/cm² in Leibovitz's L-15 medium supplemented with 2 mM L-glutamine (90%) and 10% fetal bovine serum. The cells are collected after treatment with 0.25% trypsin, 0.02% EDTA at 37° C. for 2 to 5 minutes. The trypsinized cells are then diluted with 30 ml growth medium and plated at a density of 50,000 cells per well in a 96 well plate (200 μl/well). The following day, cells are treated with either compound buffer alone, or compound buffer containing a chemical agent to be tested, for a defined period of time, e.g. 24 hours. The media is then removed, the cells lysed and the RNA recovered using the RNAeasy reagents and protocol obtained from Qiagen. RNA is quantitated and 10 ng of sample in 1 μl are added to 24 μl of Taqman reaction mix containing 1× PCR buffer, RNAsin, reverse transcriptase, nucleoside triphosphates, amplitaq gold, tween 20, glycerol, bovine serum albumin (BSA) and specific PCR primers and probes for a reference gene (18S RNA) and a test gene (Gene X). Reverse transcription is then carried out at 48° C. for 30 minutes. The sample is then applied to a Perkin Elmer 7700 sequence detector and heat denatured for 10 minutes at 95° C. Amplification is performed through 40 cycles using 15 seconds annealing at 60° C. followed by a 60 second extension at 72° C. and 30 second denaturation at 95° C. Data files are then captured and the data analyzed with the appropriate baseline windows and thresholds.

The effect of each chemical agent on gene expression is then calculated for all of the treatments. This procedure is repeated for each of the genes in the selected set, and the relative expression ratios for each pair of genes is determined (i.e., a ratio of expression is determined for each target gene versus each of the other genes for which expression is measured, where each gene's absolute expression is determined relative to the reference gene for each compound, or chemical agent, to be screened). The samples are then scored and ranked according to the degree of alteration of the expression profile in the treated samples relative to the control. The overall expression of the set of genes relative to the controls, as modulated by one chemical agent relative to another, is also ascertained. Chemical agents or reference treatments matching the profile are suitably marked in the appropriate database.

The genes to be screened in the different steps of the methods of the invention may be studied in vitro, such as where the selected set of genes is present in some type of plastic vessel and transcription is measured under defined test conditions that promote gene expression. Alternatively, the selected set of genes may be present within a cell at the time that the reference treatment(s) or compound library are screened. In such a procedure, the cells are subjected to suitable lysis procedures and the transcription product recovered in purified or unpurified form for further analysis. The identity of such transcripts is then readily determined by methods well known in the art, such as those using commercially available microarray produces.

Alternatively, the expression patterns using the selected set of genes can be conducted by measuring the production of other expression products, such as polypeptides encoded by the genes of the selected set. Where such polypeptides have identifiable enzymatic or other activity such can be measured. Otherwise, methods, such as immunological methods or standard proteomics methods, are available to identify the polypeptides produced by expression of the plurality of genes or selected set of genes utilized in the method of the invention.

Thus, using the methods of the present invention, one can run a single screen that identifies distinct compounds that are active against all targets expressed within a given cell. In a preferred embodiment, this represents ‘whole-genome screening’ whereby a compound library is interrogated in a single assay for compounds that are active against any target in the genome.

Although presented in terms of the use of gene expression as the screening assay, the methods of the invention are easily applied to the monitoring of other cellular components such as proteins, peptides, or metabolic products, or any combination thereof, including the amount of such products produced or the activity of such products, for example, where an expressed polypeptide has enzymatic activity.

In accordance with the present invention, it is not essential that the Reference Treatments DB be created at the same time as the Compound Library Treatments DB. In an alternative procedure, the Compound Library Treatments DB is created first. Then, at later time points—in some cases perhaps even years later—a target of interest is modulated through either currently existing technology (e.g. siRNA) or with technology not presently available, and the treated cell is then profiled across the relevant gene panel. At that time, an in silico screen is performed against the existing Compound Library Treatments DB to identify compounds from the library that induced the same profile across the gene panel as the one observed following disruption of the specific target. If a match is determined, it is thereby concluded that those compounds from the library are affecting the same target or pathway.

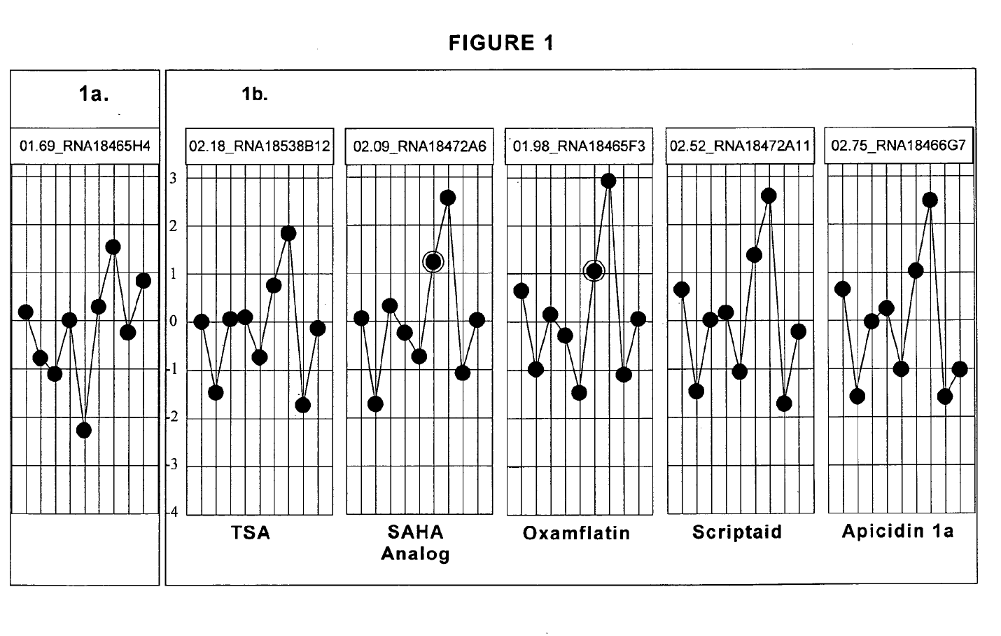

FIG. 1 shows the results of a HTS experiment on RalA/RalB. A set of 9 specific genes was identified using microarray profiling of RNAi knockdowns of Ral (an oncogene homolog that binds GDP) in a bladder cancer cell line.

RalA and RalB represent a family of very similar Ras-related GTPases that are widely distributed in tissues. Active forms of the Ral-encoded proteins bind to the exocyst complex and may be important in controlling secretion from cells. For example, it has been reported that expression of a constitutively inactive GDP-bound RalA (G26A) or silencing of the RalA gene by RNA interference results in strong impairment of the exocytotic response, that, in some cells, RalA co-localizes with phospholipase D1 (PLD1) at the plasma membrane and that reduction of endogenous RalA expression level interferes with the activation of PLD1 observed in secretagogue-stimulated cells, leading to the conclusion that RalA is a positive regulator of calcium-evoked exocytosis of large dense core secretory granules, suggesting that stimulation of PLD1 and consequent changes in plasma membrane phospholipid composition is a major function of RalA. (See Vitale et al., J. Biol. Chem., Vol. 280, Issue 33, 29921-29928, Aug. 19, 2005).

During the course of the gene screen conducted herein, a set of anticancer reference treatments was also run across this same 9 gene set. Although no library compounds were identified that matched the profile of siRNA knockdown of Ral, all HDAC inhibitor reference treatments induced a pronounced and reproducible profile across the 9 gene set. It should be noted that no prior profiling with HDAC inhibitors was used in the selection of the gene set used in this screen. These results serve to demonstrate that a gene set initially selected for a different purpose (i.e., identification of Ral inhibitors) nevertheless reliably reported on a completely different and separable activity (i.e. inhibition of HDAC).

In one aspect of the present invention, a library of compounds is maintained along with gene expression profiles for all of the compounds in the library for a selected gene set (here, a set of 9 genes). When a reference treatment is identified for a given disease, such as treatment with a gene specific siRNA, the gene profile of this treatment with the selected gene set is then determined and compared with the profiles of the compounds of the maintained library to find a close match, which may mean the same qualitative profile (some genes enhanced while others are inhibited) and, further, a quantitative profile, wherein the same genes are enhanced or inhibited to the same extent by a reference compound. Thus, for qualitative purposes, the overall general pattern is matched whereas, once this is identified, the compound showing the closest quantitative match as to each of the genes in the set is determined. After such identification, the selected library compound may be further studied for its effect on the disease process, such as its effect on cancer or a selected form of cancer. In addition, such a compound may form the basis for construction of additional analogs that may show greater efficacy in attenuating the disease process. For diseases such as cancer, characterized by cellular de-differentiation and proliferation, the effects of the compound on reducing proliferation or enhancing differentiation, or both, may then be ascertained.

By way of non-limiting example, a series of siRNAs can be tested to determine which, if any, has an advantageous effect on a particular disease, such as leukemia. This siRNA is then be tested against the selected set of genes to obtain a profile, which is then matched to the profiles exhibited by the library of compounds (which library might be formed combinatorialy or which may consist of many structurally diverse compounds) to find a match, the latter providing a possible treatment for the disease, or, at least, a starting point for developing structural analogs for further testing in vitro or in vivo.

In accordance with the foregoing, the present invention provides screening assays for identifying biologically active agents, whether the underlying chemical structures are novel or otherwise, based on the action of such agents to modulate the selected set of genes in a manner similar to that of an established modulating agent. In applying the methods of the claimed invention, it is to be understood that the profile databases generated in accordance with the invention may include a mixture of several types of data, including but not limited to gene expression data, proteomics data, metabolomics data, cellular morphology data, or biochemical data. Thus, while a chemical compound database may exist, comprising profiles of hundreds of thousands of members with a particular gene panel, the spectrum of said profiles with the gene panel may be different where a different cell type is being studied or where the same cell type has been screened for inclusion in the relevant databases but where screens have been performed under different physiological conditions.

For example, the compound library treatments database may contain a spectrum of profiles or expression patterns (one pattern for each of the compounds in the library) conducted with cell line A under a specified first set of physiological conditions. The Reference Treatments database may contain expression patterns for the same selected set of genes for cell line A under the same set of conditions where the profiles or patterns in the Reference Treatments database were generated using a series of siRNAs specific for different genes of the cells of the cell line.

By way of non-limiting example, to find a compound active on a particular target site (of a selected cell type), or having a desired effect on a particular physiological function, one probes the Reference Treatments database to identify the profile of an siRNA specific for that target. If the desired profile exists, the user then screens the compound library database, in silico, for a compound exhibiting the same or similar profile or expression pattern with the same selected set. If a match is found then the relevant member of the compound library database is identified as a compound useful, at least as a starting point, for development into an authentic therapeutic or biologically active agent. Alternatively, If the desired profile does not exist in the Reference Treatments database then a modulator, such as an siRNA, can be fashioned and utilized to generate an expression pattern with the selected set and said pattern is then probed, in silico, with the compound library database to determine if a match can be found. Either way, the candidate compound, or compounds, for further study is identified.

In one embodiment, the reference treatment of step (b) exhibits an expression profile that is entered into the Reference Treatments database. As subsequent reference treatments are screened, the resulting profiles with the selected set of genes are also entered into the Reference Treatments database. Thus, if an agent is sought that will inhibit the growth or metastasis of, or kill, cancerous cells of a particular type, a reference treatment, preferably an siRNA found to kill such cells, is screened with the selected set to identify its expression pattern, which pattern is then matched to that of one or more compounds of the compound library treatments database, thereby identifying one or more agents (of the compound library treatments database) likely to be useful in treating the cancer or at least an agent likely to provide a lead toward finding a successful agent, which will normally have very similar structure. It should be noted that steps (a) and (b) of the methods of the invention need not be performed in any particular order and the compound library treatments database and Reference Treatment database may each be generated at different times. In addition, at least some of the data present in either database may be derived from other databases or from public domain source, such as the published literature, and all of the entries in said databases need not be derived exclusively by de novo wet bench procedures.

In a highly specific but non-limiting example, where the desired target is related to neoplastic activity, an siRNA is determined to modulate the expression of 10 genes (constituting all or part of the selected set) found in a colon cancer cell type, such as an adenocarcinoma, whereby these genes show a varying pattern of expression following contacting of such a cell with, or introduction into such cell of, the siRNA. Such siRNA may be specific for one of the modulated genes, or one of the genes of the selected set that is not modulated, or possibly even a gene that is not part of the selected set although the siRNA still affects genes of the selected set. As a result of the screening, 7 of the genes (arbitrarily referred to herein as genes 1-7) of the selected set show reduced expression while 3 other genes (arbitrarily referred to herein as genes 8-10) show expression, or increased expression, as a result of said contacting, the remaining genes of the selected set, if any, exhibiting no change in activity. This set of 10 genes thus represents a cancer related selected set. Each of said 10 genes may be modulated to a different extent by the siRNA. For example, expression of “gene 1” may be reduced to a level where expression is no longer detected while “gene 2” is reduced to half its expression when the siRNA is not present. The relative levels of expression of each of the genes in the presence and absence of the siRNA serves to establish the activity profile. Expression in the absence of contacting with such test compound establishes a basal or steady state activity profile.

In accordance with the invention, once a basal activity profile or steady state activity profile is known for a selected set, cells of other types and tissues, related or unrelated to each other, can then be determined and the data used to set up additional Reference Treatment databases or compound library treatments databases. It is contemplated by the invention that such steady state levels may be determined without de novo determinations but through use of databases, including public databases, that provide expression levels of identified genes in diverse cells and tissues from varied sources and from different species.

Thus, in conducting the methods of the invention, it is not essential to determine activity profiles for all the compounds to be contained in the compound library treatments database or all of the reference treatments of the Reference Treatments database. At least some of the data may already be contained, in one way or another, in public or other databases. Once this information is attained and assembled as disclosed herein and utilized as recited in the steps of the methods of the invention, at least the initial steps of the claimed method are deemed to have been carried out.

In other embodiments of the above-recited method, the expression is transcription. In addition, the change in expression pattern of step (a) or (b) may be determined by determining synthesis of RNA, including either amount of RNA produced, rate of production, or both. In another embodiment, the change in expression pattern of step (a) or (b) is determined by determining polypeptide synthesis. In a further such embodiment, the change in expression profile of step (b) is determined by determining enzyme inhibitory activity. The identify an expression profile, such determining may be a combination of the foregoing, such as where transcription to produce RNA is determined, or known, for some genes and protein synthesis and/or activity is determined, or known, for others. In addition, it may be known for some genes of the selected gene set and determined for other genes of the selected gene set.

In one embodiment, the test compound identified via step (c) is not an agent possessing known biological activity so that the methods of the invention find use in identifying novel agents with a selected biological activity.

Thus, the present invention further relates to compounds identified as having biological activity by the methods of the invention. In preferred embodiments, such identified compounds have therapeutic activity, and/or anti-neoplastic activity, and/or enzyme inhibitory, as first determined by the methods disclosed herein but such activity is realized using cells or tissues whose susceptibility, or resistance, to the effects of the test compound were not previously appreciated.

Thus, the invention also encompasses cases where the agent, or test compound, may have been known to have a biological activity in one kind of cell but not others that can be tested using the methods herein. In addition, such known, or suspected, biological activity may have been previously determined to involve a different molecular mechanism than controlled by the genes of the selected set utilized herein.

What is claimed is:

1. A method for identifying one or more members of a compound library having physiological activity similar to that of a reference treatment, comprising:
(a) maintaining in a database gene expression patterns produced by individual compounds of a library of compounds, said gene expression patterns having been obtained for each of a selected set of genes in a cell, which set of genes and cell are the same for each of said individual compounds;
(b) obtaining a gene expression pattern for a reference treatment for said selected set of genes in said cell;
(c) comparing said gene expression pattern for said reference treatment with said gene expression pattern for the compounds of said library; and
(d) selecting one or more compounds of said library for testing for activity based on similarity between said gene expression pattern for said library compound and said gene expression pattern for said reference treatment thereby identifying one or more members of a compound library having physiological activity similar to that of a reference treatment.

2. The method of claim 1, wherein said selected set of genes comprises fewer than all of the genes of the genome of said selected cell type.

3. The method of claim 1, wherein said selected set of genes comprises no more than 200 genes.

4. The method of claim 1, wherein said selected set of genes comprises no more than 100 genes.

5. The method of claim 1, wherein said selected set of genes comprises no more than 50 genes.

6. The method of claim 1, wherein said selected set of genes comprises no more than 40 genes.

7. The method of claim 1, wherein said selected set of genes comprises no more than 10 genes.

8. The method of claim 1, wherein said selected set of genes comprises at least 9 genes.

9. The method of claim 1, wherein the reference treatment is an siRNA.

10. The method of claim 1, wherein the reference treatment is an anti-sense molecule.

11. The method of claim 1, wherein the reference treatment is a small molecule compound.

12. The method of claim 1, wherein the reference treatment is a peptide or protein.

13. The method of claim 1, wherein the reference treatment is a virus particle, infectious agent, or toxin.

14. The method of claim 1, wherein step (b) is repeated at least once using a different reference treatment.

15. The method of claim 1, wherein step (b) is repeated more than once and wherein each repetition uses a reference treatment different from that used in any of the other repetitions or in the initial step (b).

16. The method of claim 15, wherein the gene expression patterns resulting from each step (b) are maintained in a database.

17. The method of claim 1, wherein the similarity of step (c) is determined using in silico search of the database of step (a).

18. The method of claim 1, wherein the library of compounds of (a) comprises 1 compound.

19. The method of claim 1, wherein the library of compounds of (a) comprises at least 2 compounds.

20. The method of claim 1, wherein the library of compounds of (a) comprises at least 50,000 chemical compounds.

21. The method of claim 1, wherein the library of compounds of (a) comprises at least 100,000 chemical compounds.

22. The method of claim 1, wherein the library of compounds of (a) comprises at least 200,000 chemical compounds.

23. The method of claim 1, wherein the library of compounds of (a) comprises at least 500,000 chemical compounds.

24. The method of claim 1, wherein the library of compounds of (a) comprises at least 1,000,000 chemical compounds.

25. The method of claim 1, wherein the gene expression patterns of step (b) were obtained by determining expression of said genes in a cell.

26. The method of claim 1, wherein the gene expression patterns of step (b) were obtained by determining expression of said genes in silico.

27. The method of claim 1, wherein the activity of said gene expression in (a) is transcription.

28. The method of claim 27, wherein said transcription determined by determining formation of mRNA.

29. The method of claim 27, wherein said transcription is determined by determining formation of polypeptide.

30. The method of claim 27, wherein said transcription is determined by determining activity of one or more polypeptides encoded by said selected set of genes.

31. The method of claim 1, wherein the activity of said gene expression in (b) is transcription.

32. The method of claim 31, wherein said transcription determined by determining formation of mRNA.

33. The method of claim 31, wherein said transcription is determined by determining formation of polypeptide.

34. The method of claim 31, wherein said transcription is determined by determining activity of one or more polypeptides encoded by said selected set of genes.
